(19) United States
(12) Patent Application Publication
(10) Pub. No.: US 2015/0356449 A1
(43) Pub. Date: Dec. 10, 2015

(54) USER LOCATION INTEREST INFERENCES

(71) Applicant: Microsoft Corporation, Redmond, WA (US)

(72) Inventors: Maxim Vainstein, Redmond, WA (US); Jose Saura, Kent, WA (US); Sergey Galuzo, Woodinville, WA (US); Meir Ben Itay, Sammamish, WA (US)

(21) Appl. No.: 14/297,763

(22) Filed: Jun. 6, 2014

(51) Int. Cl. G06N 5/04

(52) U.S. Cl. CPC G06N 5/047

(57) ABSTRACT

One or more techniques and/or systems are provided for identifying a location interest inference for a first user. A first set of user signals (e.g., search history, social network posts, etc.) associated with the first user may be evaluated to identify a first user location interest pattern indicative of location interests of the first user. Social signals (e.g., phone calls, emails, photo tags, shared content, etc.) between the first user and other users may be evaluated to identify a second user having a social activity relevance score above a relationship threshold with respect to the first user. A second user location interest pattern may be generated for the second user based upon user signals associated with the second user. The first user location interest pattern and the second user location interest pattern may be aggregated to create the location interest inference indicative of refined locational interests of the first user.

### BACKGROUND

Many users may research locations and/or plan trips using various travel websites, vacation applications, mapping services, etc. In an example, a user may visit Olympic news websites, view Olympic event videos through a video sharing website, read social network posts about the Olympics, download Olympic images from an image sharing website, and/or perform a variety of tasks associated with researching winter Olympics in Russia. In another example, the user may plan a vacation to a beach by utilizing a map application to plan a driving route to the beach, make a beach restaurant reservation using a restaurant app, and book a hotel using a hotel application.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for identifying a location interest inference for a first user and/or for generating a story book for a location associated with a location interest inference are provided herein. A first set of user signals associated with a first user may be evaluated (e.g., given user consent) to generate a first user location interest pattern for the first user. For example, emails, calendar entries, web browsing history, social network posts, and/or a variety of other user signals may be evaluated to determine that the first user may have varying degrees of interest in Chicago, New York, a local beach, and/or other locations.

Social signals between the first user and one or more users may be evaluated (e.g., given user consent) to identify a second user having a social activity relevance score above a relationship threshold with respect to the first user. For example, a relatively high social activity relevance score may be assigned to the second user based upon frequency, volume, content, and/or patterns of user interactions between the first user and the second user (e.g., social network posts, photo tags, messages, phone calls, an increase in communication indicating a discussion of an interesting location, and/or other interactions between the first user and the second user, which may indicate a degree of friendship or relationship between the users). A second set of user signals associated with the second user may be evaluated (e.g., given user consent) to generate a second user location interest pattern for the second user. For example, emails, calendar entries, web browsing history, social network posts, and/or a variety of other user signals may be evaluated to determine that the second user has a strong interest in Chicago, Rome, a national park, and/or other locations. The first user, the one or more users and/or the second user may respectively take affirmative action to provide opt-in consent to allow access to and/or use of the first set of user signals, the social signals, and/or the second set of user signals, such as for the purpose of location interest inference identification (e.g., where a user responds to a prompt regarding the collection and/or use of such information).

The first user location interest pattern and the second user location interest pattern may be aggregated to identify a location interest inference for the first user. For example, the location interest inference may indicate that the first user has a strong interest in researching Chicago based upon the first user and the second user communicating about the history of Chicago. Content, such as Chicago history book purchase suggestions, a Chicago photo sharing app, a Chicago video archive website, and/or other content associated with the location interest inference, may be provided to the first user. In this way, social signals may be utilized to identify locations that may be interesting to users (e.g., previously visited locations, current locations, future locations, and/or interesting locations).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

DESCRIPTION OF THE DRAWINGS

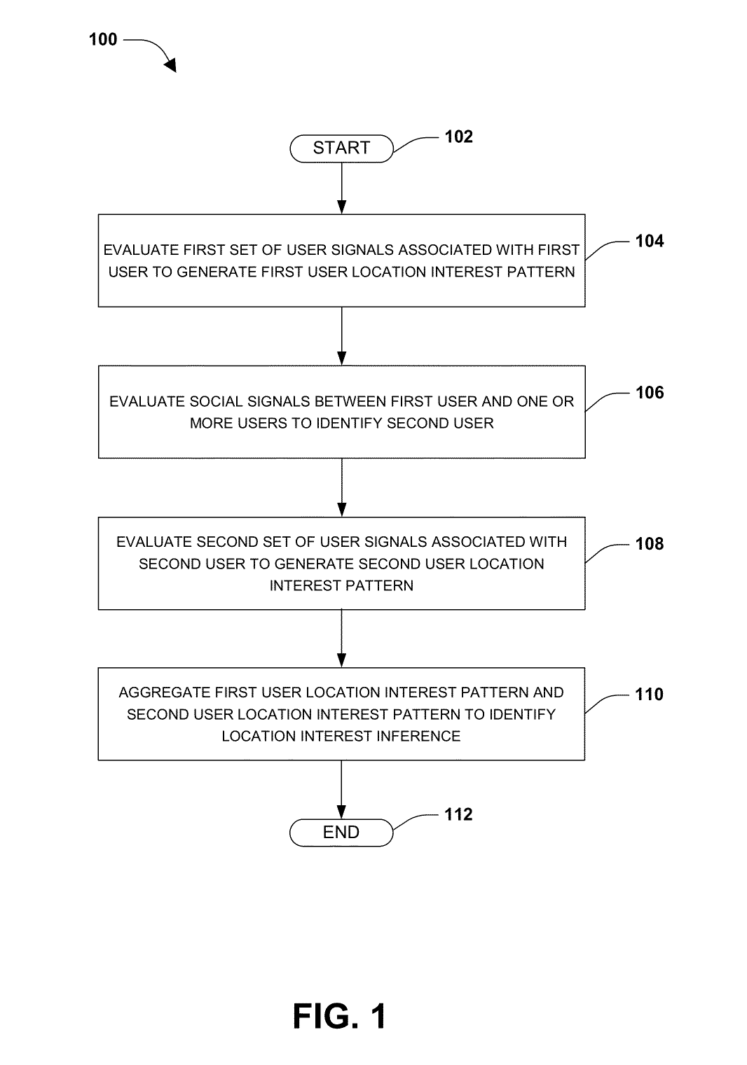

FIG. 1 is a flow diagram illustrating an exemplary method of identifying a location interest inference for a first user.

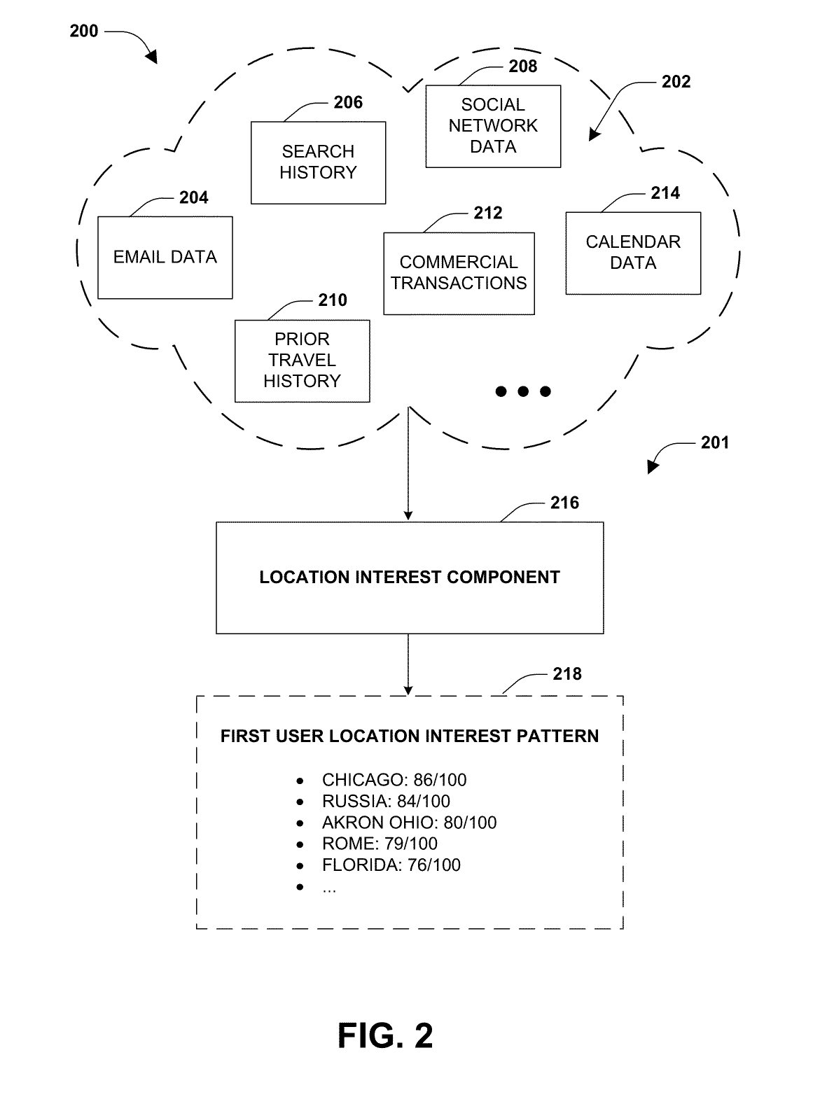

FIG. 2 is an illustration of an example of generating a first user location interest pattern.

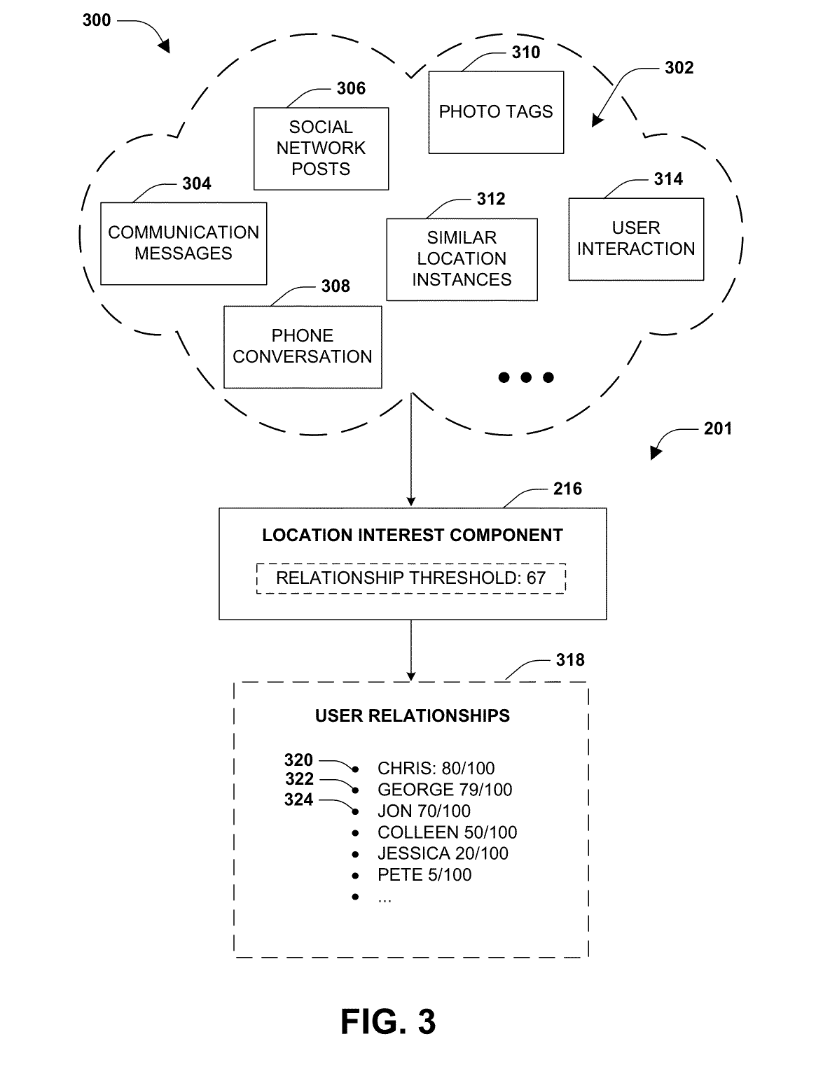

FIG. 3 is an illustration of an example of identifying user relationships.

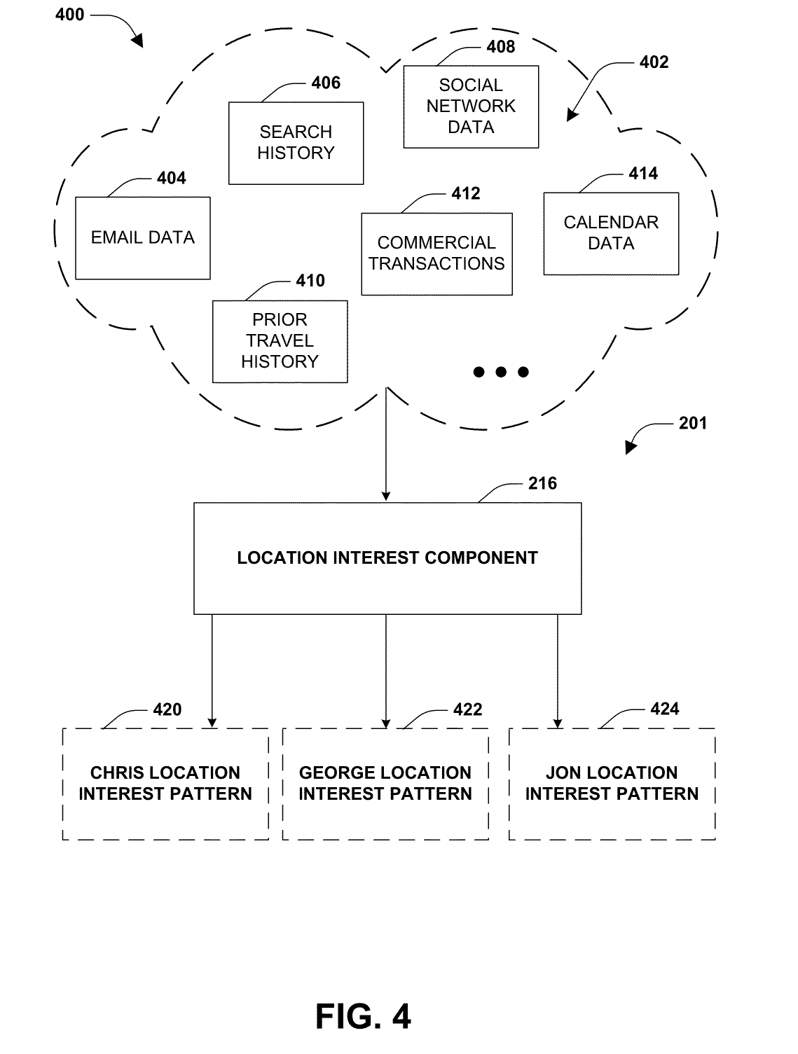

FIG. 4 is an illustration of an example of generating one or more user location interest patterns.

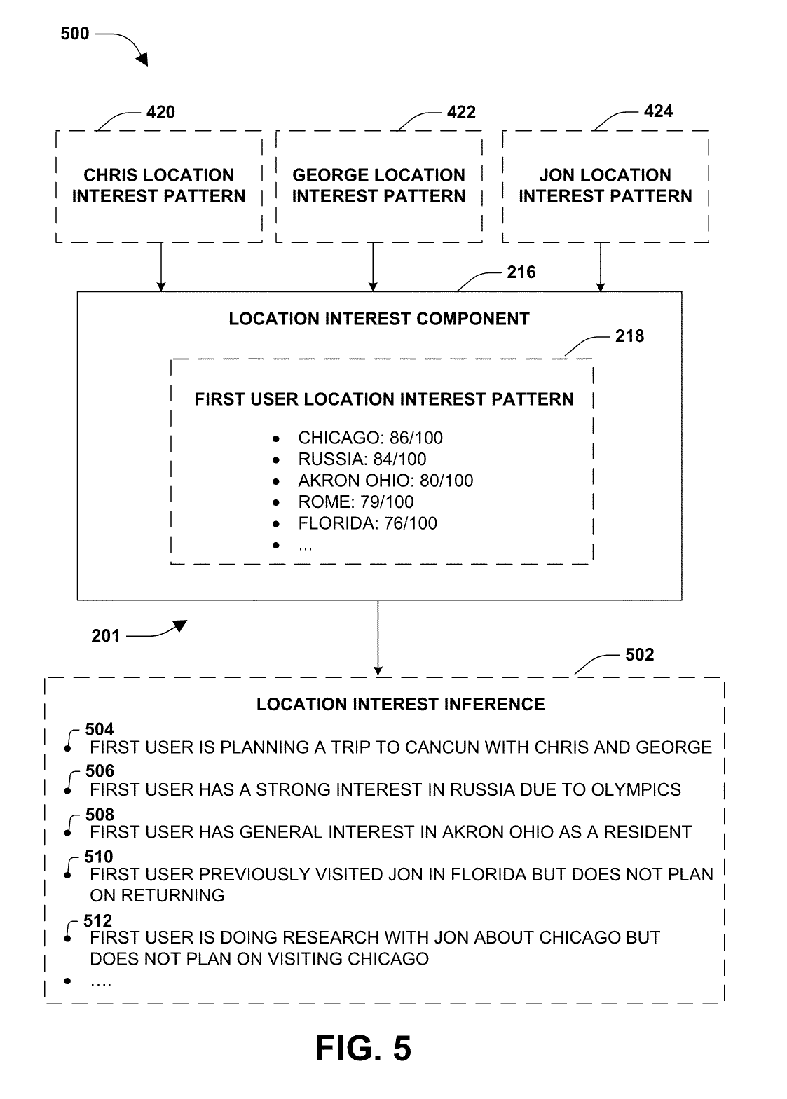

FIG. 5 is an illustration of an example of identifying a location interest inference.

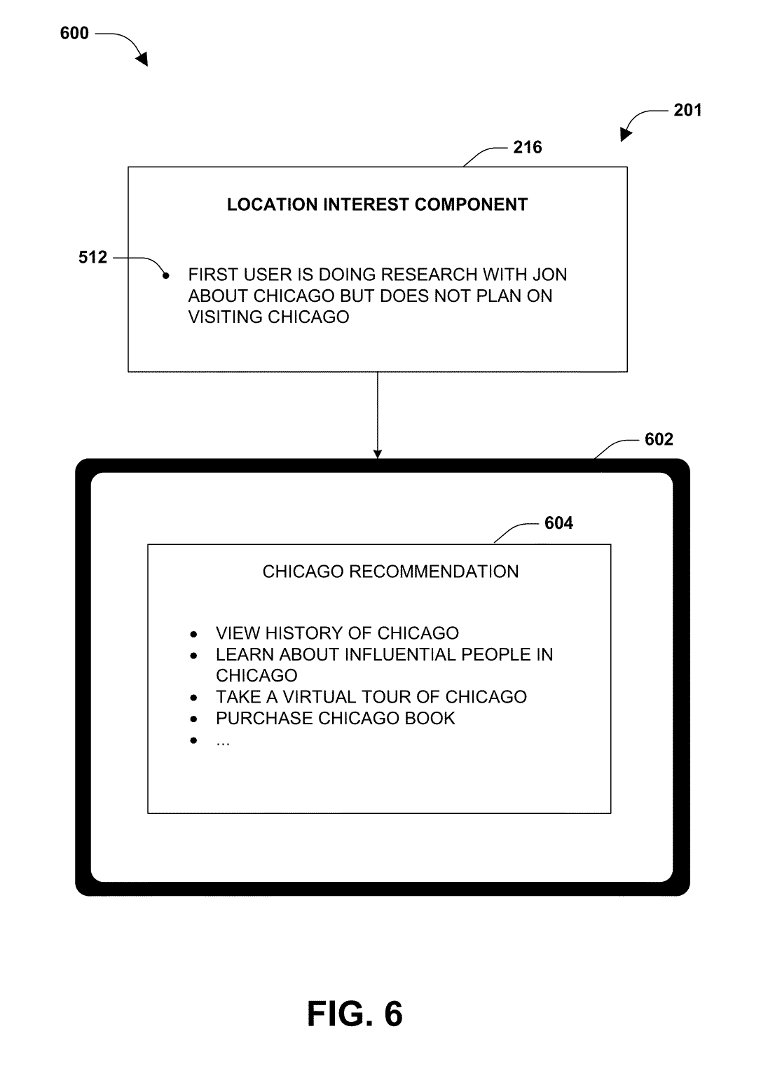

FIG. 6 is an illustration of an example of providing a recommendation based upon a location interest inference.

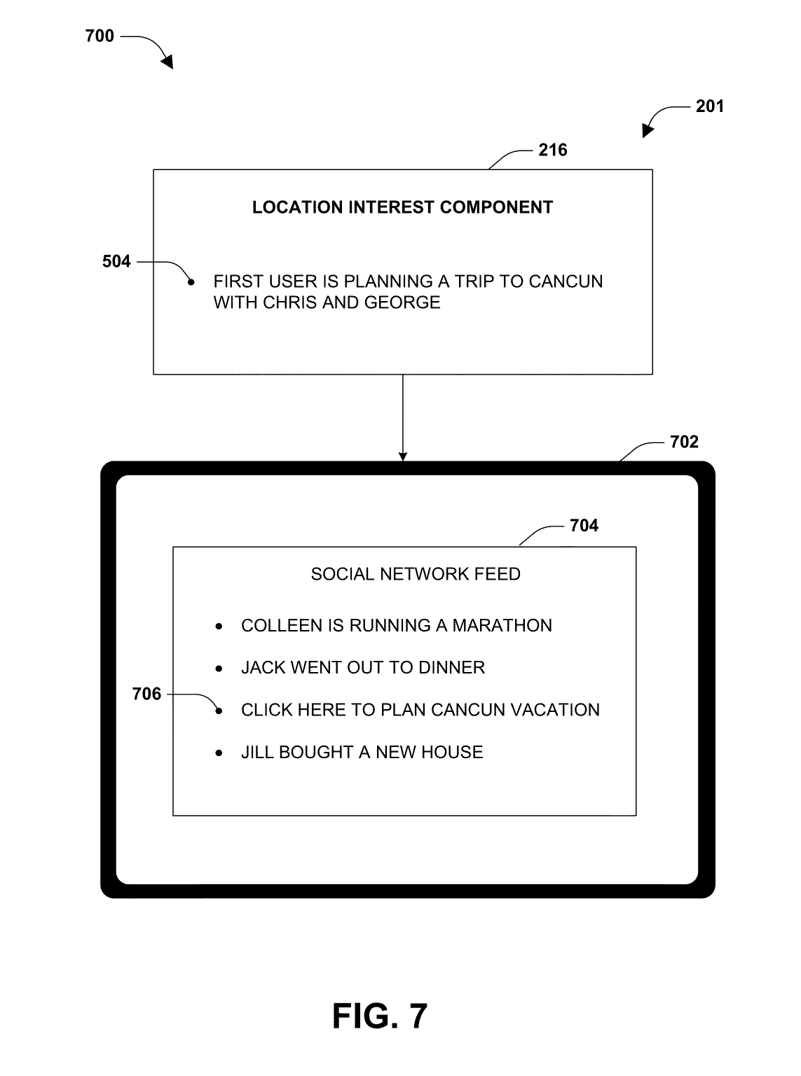

FIG. 7 is an illustration of an example of providing a social network feed item based upon a location interest inference.

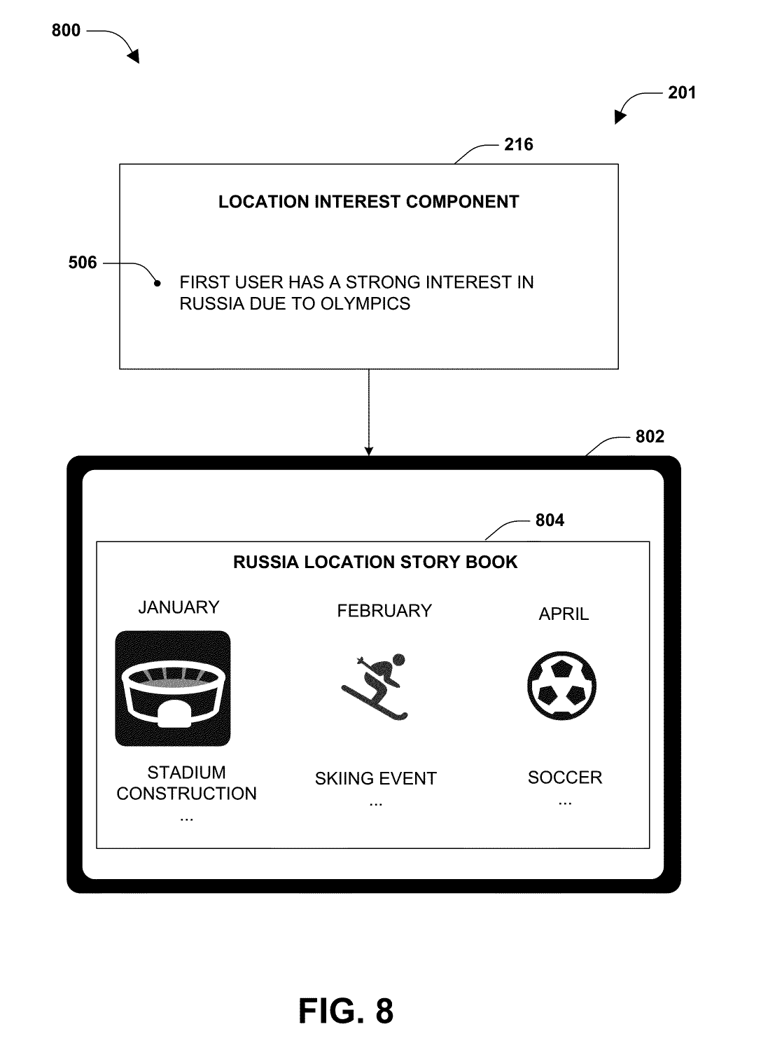

FIG. 8 is an illustration of an example of providing a location story book based upon a location interest inference.

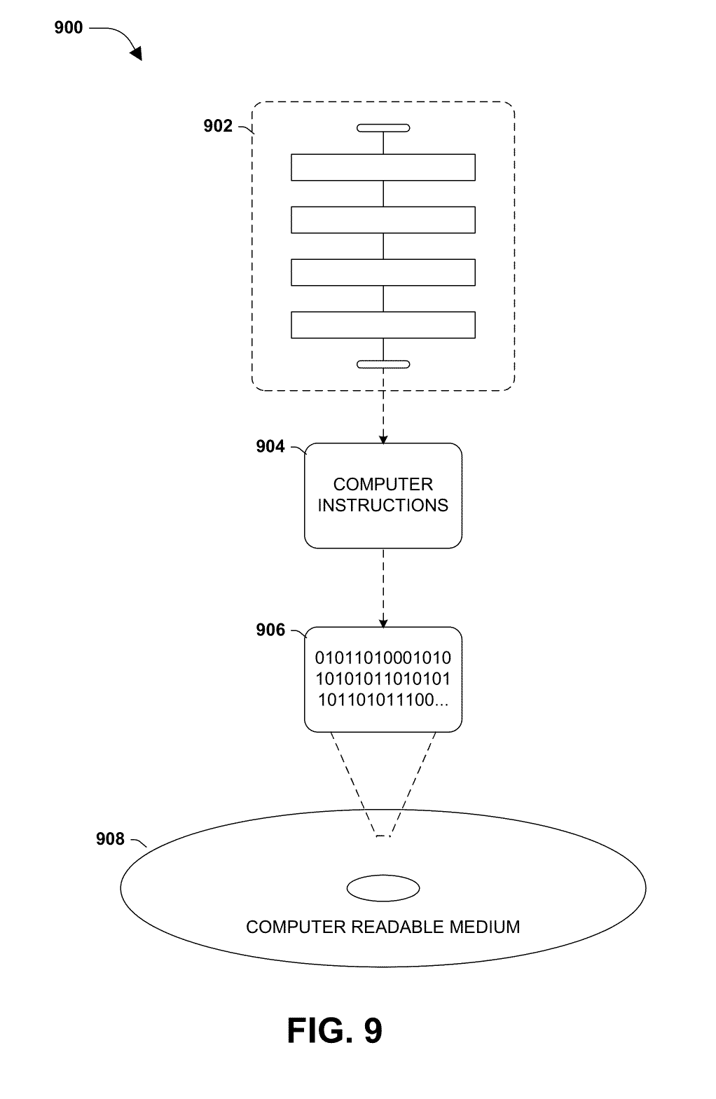

FIG. 9 is an illustration of an exemplary computer readable medium wherein processor-executable instructions configured to embody one or more of the provisions set forth herein may be comprised.

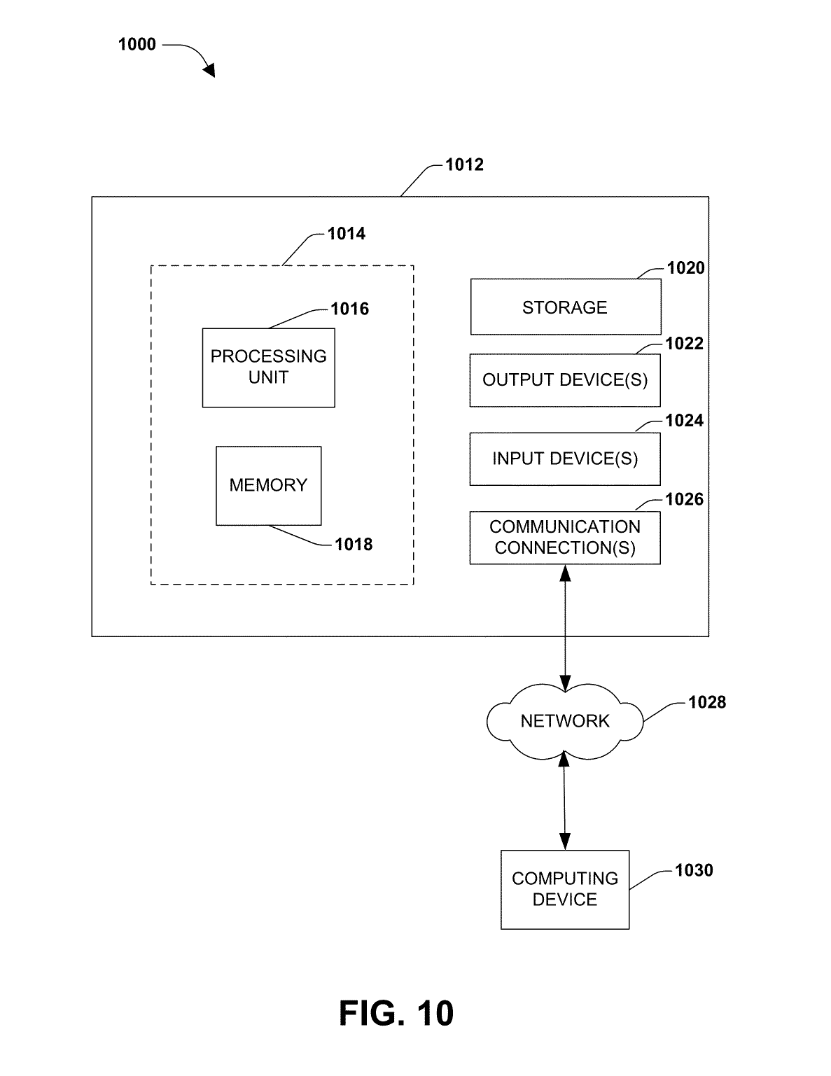

FIG. 10 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for identifying a location interest inference for a first user and/or for generating a story book for a location associated with a location interest inference are provided herein. User signals of a user and/or of other users with which the user has a relationship may be evaluated to identify locations with which the user may have an interest. For example, email communication, phone calls, social network posts, photo tags, and/or other user interactions between the user and other users, such as friends, may be evaluated to determine that the user has a strong interest in content about Russia based upon the user and the other users discussing Russia and the winter Olympics. The user and/or the other users may take affirmative action to provide opt-in consent to allow access to and/or use of user signals and/or social signals, such as for the purpose of location interest inference identification (e.g., where a user responds to a prompt regarding the collection and/or user of such information).

Accordingly, content about Russia may be provided to the user, such as photos, book purchase suggestions, tailored search results, social network feed items, music, maps, an invitation to a public event (e.g., an opportunity to join a social network discussion about the winter Olympics), an invitation to a private event (e.g., an opportunity to purchase a live online event to participate in a virtual tour of the Olympic village), and/or other content about Russia and/or the winter Olympics. In an example, a location story may be created for the location interest inference, and may be provided to the user. For example, the location story may comprise a logical order of photos, news stories, events, personal content (e.g., photos from a previous trip by the user to Russia), and/or other content associated with Russia.

An embodiment of identifying a location interest inference for a first user is illustrated by an exemplary method 100 of FIG. 1. At 102, the method starts. At 104, a first set of user signals associated with a first user may be evaluated to generate a first user location interest pattern for the first user. For example, the first set of user signals may comprise social network information of the first user (e.g., a post about a school research project about the winter Olympics), a commerce transaction (e.g., a video streaming package for winter Olympic events), calendar data (e.g., an entry about purchasing beach towels and suntan lotion), website browsing history (e.g., websites corresponding to Russia, the winter Olympics, Cancun, a national park, etc.), prior travel history (e.g., GPS information indicating that the user recently visited the national park), user travel patterns (e.g., a home check-in indicating a home location of the first user), and/or a wide variety of other information (e.g., a receipt document or other files stored on a computing device). In an example, the first user location interest pattern may comprise a first vector of locations and datetimes indicating that the user has varying degrees of interest in Russia (e.g., a current research interest location), Cancun (e.g., a future travel location), a national park (e.g., a prior travel location), and/or other locations.

At 106, social signals between the first user and one or more users may be evaluated to identify a second user having a social activity relevance score above a relationship threshold with respect to the first user. For example, the social signals may comprise information relating to content, frequency, volume, communication patterns, and/or other user interaction statistics for email communication, phone conversations, social network posts, photo tags, co-op videogame sessions, and/or a variety of other user interactions between the user and the one or more users, which may indicate varying degrees which with the user is friends with other users. The social activity relevance score may be weighted based upon communication patterns. In an example, a relatively lower weight may be used for habitual or routine user interaction, which may be indicative of non-interesting locational communication. A relatively higher weight may be used for increases in user interaction (e.g., a spike in communication), which may be indicative of interesting location communication such as planning for an upcoming trip or sharing information about a research project for a particular location.

At 108, a second set of user signals associated with the second user may be evaluated to generate a second user location interest pattern for the second user. In an example, the second user location interest pattern may comprise a second vector of locations and datetimes indicating that the second user has varying degrees of interest in Russia (e.g., a current research interest location), the beach, Chicago, Rome, a national park (e.g., a prior travel location), Paris, and/or other locations. In an example, one or more locational interests of the first user may intersect or correspond to one or more locational interests of the second user, which may indicate that the first user has an increased interest in such intersecting locational interests (e.g., the first user and the second user may be currently researching Russia for a coauthored research article on the winter Olympics). In another example, one or more locational interests of the second user may be used to supplement locational interests of the first user (e.g., the second user may have a strong interest in a beach, which may be interesting to the first user based upon previous joint vacations of the first user and the second user to Cancun or other beach destinations).

At 110, the first user location interest pattern and the second user location interest pattern may be aggregated to identify a location interest inference for the first user. For example, the first vector and the second vector may be intersected to identify intersecting locational interests and/or supplemental locational interests for the first user. In an example, the second user location interest pattern may be weighted prior to the aggregating based upon the social activity relevance score between the second user and the first user (e.g., locational interests of the second user may be taken into greater consideration the stronger the relationship between second user and the first user). In an example, user location interest patterns of one or more additional users, such as a third user, having social activity relevance scores above the relationship threshold may be aggregated with the first user location interest pattern and the second location interest pattern to create the location interest inference. The user location interferes patterns may be weighted based upon corresponding social activity relevance scores.

The location interest inference may correspond to a prior user location of the first user, a current location of the first user, a future location of the first user, or a location of interest to the first user (e.g., a location that the first user has an interest in learning about or obtaining news about, but is not interested in traveling to the location). In an example, the location interest inference may indicate that the first user and the second user are planning to visit a location. In another example, the location interest inference may indicate that the first user and the second user have an interest in a location (e.g., a joint research project regarding Russia).

In an example, content, corresponding to the location interest inference, may be provided to the user. For example, promotional offers, advertisements, recommendations, private events, public events, research information, user photos of a prior user location visited by the user, news stories, and/or a plethora of other content may be provided through a web service, an operating system alert, a recommendation, a search result page, an application, a social network feed, a promotion interface, etc. In an example, a location story may be generated based upon the location interest inference. For example, news stories, photos, videos, and/or a variety of other information about Russia may be provided to the user through an interactive location story interface, which may be used by the user for researching Russia. At 112, the method ends.

FIGS. 2-8 illustrate examples of a system 201, comprising a location interest component 216, for location interest inference identification. FIG. 2 illustrates an example 200 of generating a first user location interest pattern 218. The location interest component 216 may be configured to evaluate a first set of user signals 202 (e.g., given user consent) associated with a first user to generate the user location interest pattern 218. Email data 204, search history 206, social network data 208, prior travel history 210, commercial transactions 212, calendar data 214, and/or other user signals may be evaluated. In an example, the first user location interest pattern 218 may indicate that the user has varying degrees of a locational interest in Chicago, Russia, Akron Ohio, Rome, Florida, and/or other locations. For example, the social network data 208 may comprise various social network posts by the first user about the winter Olympics in Russia, the calendar data 214 may comprise an entry that the user has a Russia research project task, the commercial transactions 212 may comprise a Russian athletic history book purchase, etc. The prior travel history 210 and user photos may indicate that the user visited Rome in 2010. In this way, the first user location interest pattern 218 may comprise a first vector of locations, datetimes (e.g., indicative of a prior, current, and/or future locational association), and/or degrees of interest in such locations.

FIG. 3 illustrates an example 300 of identifying user relationships 318 between the first user and one or more users. The location interest component 216 may be configured to evaluate social signals 302 (e.g., given user consent), such as communication messages 304, social network posts 306, photo tags 310, phone conversations 308, similar location instances 312 (e.g., the first user and a second user visiting a national park together), user interactions, etc., between the first user and one or more users to identify the user relationships 318. Social activity relevance scores may be assigned to users based upon content, frequency, volume, and/or communication patterns (e.g., routine communication indicating discussions of relatively non-interesting locations; an increase/spike in communication indicating discussions of relatively interesting locations such as planning of a vacation) of communication and user interactions between the first user and one or more users. For example, Chris 320 may be assigned a social activity relevance score of 80, George 322 may be assigned a social activity relevance score of 79, Jon 324 may be assigned a social activity relevance score of 70, Colleen may be assigned a social activity relevance score of 50, Jessica may be assigned a social activity relevance score of 20, etc. Chris 320, George 322, and Jon 324 may have social activity relevance scores above a relationship threshold of 67 with respect to the first user, and thus may be selected for further locational interest evaluation for the first user.

FIG. 4 illustrates an example 400 of evaluating user signals 402 associated with Chris 320, George 322, and Jon 324 to generate a Chris location interest pattern 420, a George location interest pattern 422, and a Jon location interest pattern 424. For example, email data 404, search history 406, prior travel history 410, social network data 408, commercial transactions 412, calendar data 414, and/or other user signals associated with Chris 320, George 322, and/or Jon 324 may be evaluated. The Chris location interest pattern 420 may be weighted based upon the social activity relevance score of 80 for Chris 320, the George location interest pattern 422 may be weighted based upon the social activity relevance score of 79 for George, and the Jon location interest pattern 424 may be weighted based upon the social activity relevance score of 70 for Jon (e.g., locational interests of Chris 320 may have more influence than locational interests of Jon 324 when identifying location interest inferences for the first user).

FIG. 5 illustrates an example 500 of identifying a location interest inference 502 for the first user. The location interest component 216 may aggregate the first user location interest pattern 218 with the Chris location interest pattern 420, the George location interest pattern 422, and/or the Jon location interest pattern 424 to generate the location interest inference 502. In an example, a location relevance of a location to the first user may be increased when the first user location interest pattern 218 and another location interest pattern comprise the location (e.g., an intersecting location). In another example, a location relevance of a location to the first user may be decreased when merely the first user location interest pattern 218 comprises the location (e.g., a non-intersection location). In another example, a location that is not within the first user location interest pattern 218 but is within at least one location interest pattern may be considered a supplementary location for the first user (e.g., Chris 320 and George 322 may have strong interests in the Las Vegas, and thus the first user may also have a supplemental interest in Las Vegas).

The location interest inference 502 may comprises prior user locations, current user locations, future locations, and/or other locations of interest to the first user. For example, the location interest inference 502 may comprise a first indication 504 that the first user is planning a trip to Cancun with Chris 320 and George 322 (e.g., the Chris location interest pattern 420 and the George location interest pattern 422 may comprise Cancun). The location interest inference 502 may comprise a second indication 506 that the first user has a strong interest in Russia due to the Olympics (e.g., the Chris location interest pattern 420, the George location interest pattern 422, the Jon location interest pattern 424, and the first user location interest pattern 218 may comprise Russia). The location interest inference 502 may comprise a third indication 508 that the user has a general interest in Akron Ohio as a resident. The location interest inference 502 may comprise a fourth indication 510 that the first user previously visited Jon 324 in Florida but does not seem to have plans on returning (e.g., the Jon location interest pattern 424 and the first user location interest pattern 218 may comprise Florida, but user signals and/or social signals may indicate that the first user does not have an interest in returning to Florida). The location interest inference 502 may comprise a fifth indication 512 that the first user and Jon 324 are writing a research paper about Chicago but do not seem to have plans on visiting Chicago (e.g., the Jon location interest pattern 424 and the first user location interest pattern 218 may comprise Chicago, but user signals and/or social signals may indicate that the first user merely has a research interest in Chicago). In this way, the location interest inference 502 may be generated based upon aggregate locational interests of the first user and other users having relationships with the first user.

FIG. 6 illustrates an example 600 of providing a Chicago content recommendation 604 through a computing device 602 associated with the first user. The location interest component 216 may evaluate the location interest inference 502 to identify the fifth indication 512 that the first user and Jon 324 are writing the research paper about Chicago. The location interest component 216 may populate the Chicago content recommendation 604 with research content for Chicago, such as an ability to view historical information about Chicago, learn about influential people in Chicago, purchase a virtual tour of Chicago, purchase a Chicago book, etc.

FIG. 7 illustrates an example 700 of providing a Cancun social network feed item 706 through a computing device 702 associated with the first user. The location interest component 216 may evaluate the location interest inference 502 to identify the first indication 504 that the first user is planning the trip to Cancun with Chris 320 and George 322. The location interest component 216 may populate a social network feed 704 with the Cancun social network feed item 706 about planning a Cancun vacation.

FIG. 8 illustrates an example 800 of providing a Russia location story book 804 through a computing device 802 associated with the first user. The location interest component 216 may evaluate the location interest inference 502 to identify the second indication 506 that the first user has a strong interest in Russia due to the Olympics. The location interest component 216 may obtain various content about Russia, sports, and/or the Olympics, such as a stadium construction story from January, an Olympic skiing event video from February, a soccer photo from April, and/or other content. The location interest component 216 may construct the location story book 804 based upon such content.

Still another embodiment involves a computer-readable medium comprising processor-executable instructions configured to implement one or more of the techniques presented herein. An example embodiment of a computer-readable medium or a computer-readable device is illustrated in FIG. 9, wherein the implementation 900 comprises a computer-readable medium 908, such as a CD-R, DVD-R, flash drive, a platter of a hard disk drive, etc., on which is encoded computer-readable data 906. This computer-readable data 906, such as binary data comprising at least one of a zero or a one, in turn comprises a set of computer instructions 904 configured to operate according to one or more of the principles set forth herein. In some embodiments, the processor-executable computer instructions 904 are configured to perform a method 902, such as at least some of the exemplary method 100 of FIG. 1 for example. In some embodiments, the processor-executable instructions 904 are configured to implement a system, such as at least some of the exemplary system 201 of FIGS. 2-8, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1000 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Computer storage media does not, however, include propagated signals. Rather, computer storage media excludes propagated signals. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via a network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for identifying a location interest inference for a first user, comprising:
evaluating a first set of user signals associated with a first user to generate a first user location interest pattern for the first user;
evaluating social signals between the first user and one or more users to identify a second user having a social activity relevance score above a relationship threshold with respect to the first user;
evaluating a second set of user signals associated with the second user to generate a second user location interest pattern for the second user; and
aggregating the first user location interest pattern and the second user location interest pattern to identify a location interest inference for the first user.

2. The method of claim 1, comprising:
weighting the second user location interest pattern prior to the aggregating based upon the social activity relevance score.

3. The method of claim 1, comprising:
providing content, corresponding to the location interest inference, to the user.

4. The method of claim 1, the evaluating social signals comprising evaluating the social signals to identify a third user having a second social activity relevance score above the relationship threshold with respect to the first user, the method comprising:
evaluating a third set of user signals associated with the third user to generate a third user location interest pattern for the third user, the aggregating comprising aggregating the first user location interest pattern, the second user location interest pattern, and the third user location interest pattern to identify the location interest inference for the first user.

5. The method of claim 4, comprising:
weighting the second user location interest pattern prior to the aggregating based upon the social activity relevance score; and
weighting the third user location interest pattern prior to the aggregating based upon the second social activity relevance score.

6. The method of claim 1, the social signals comprising at least one of email communication, a phone conversation, a social network post, a photo tag, or user interaction between the first user and at least one other user of the one or more users.

7. The method of claim 1, the evaluating social signals comprising:
assigning a first social activity relevance score to a third user based upon routine user interaction between the first user and the third user; and
adjusting the social activity relevance score for the second user to a second social activity relevance score based upon an increase in user interaction between the first user and the second user, the second social activity relevance score greater than the first social activity relevance score.

8. The method of claim 1, comprising:
generating a location story based upon the location interest inference; and
providing the location story to at least one of the first user or the second user.

9. The method of claim 1, the location interest inference corresponding to at least one of a prior user location of the first user, a current location of the first user, a future location of the first user, or a location of interest to the user.

10. The method of claim 1, the first set of user signals comprising at least one of social network information of the first user, commerce transaction history of the first user, calendar data of the first user, website browsing history of the first user, user travel patterns, or prior travel history of the first user.

11. The method of claim 3, the providing content comprising:
providing the content through at least one of a web service, an operating system alert, a recommendation, a search result page, an application, or a promotion interface.

12. The method of claim 1, the aggregating comprising:
determining that the first user and the second user are planning to visit a location; and
including the location within the location interest inference.

13. The method of claim 1, the aggregating comprising:
determining that the first user and the second user have a shared interest in a location; and
including the location within the location interest inference.

14. The method of claim 3, the location interest inference corresponding to a prior user location of the first user and the content corresponding to news about the prior user location.

15. A system for identifying a location interest inference for a first user, comprising:
a location interest component configured to:
evaluate a first set of user signals associated with a first user to generate a first user location interest pattern for the first user;
evaluate social signals between the first user and one or more users to identify a second user having a social activity relevance score above a relationship threshold with respect to the first user;
evaluate a second set of user signals associated with the second user to generate a second user location interest pattern for the second user; and
aggregate the first user location interest pattern and the second user location interest pattern to identify a location interest inference for the first user.

16. The system of claim 15, the location interest component configured to:
assign a first social activity relevance score to a third user based upon routine user interaction between the first user and the third user; and
adjust the social activity relevance score for the second user to a second social activity relevance score based upon an increase in user interaction between the first user and the second user, the second social activity relevance score greater than the first social activity relevance score

17. The system of claim 15, the location interest component configured to:
generate a location story based upon the location interest inference; and
provide the location story to at least one of the first user or the second user.

18. The system of claim 15, the location interest component configured to:
provide content, corresponding to the location interest inference, to the user.

19. The system of claim 18, the location interest inference corresponding to a prior user location of the first user and the content corresponding to news about the prior user location.

20. A computer readable medium comprising instructions which when executed perform a method for generating a story book for a location associated with a location interest inference, comprising:
evaluating a first set of user signals associated with a first user to generate a first user location interest pattern for the first user;
evaluating social signals between the first user and one or more users to identify a second user having a social activity relevance score above a relationship threshold with respect to the first user;
evaluating a second set of user signals associated with the second user to generate a second user location interest pattern for the second user;
aggregating the first user location interest pattern and the second user location interest pattern to identify a location interest inference for the first user; and
generating a story book for a location associated with the location interest inference based upon content associated with the location.
